(19) United States
(12) Patent Application Publication
(10) Pub. No.: US 2025/0330522 A1
(43) Pub. Date: Oct. 23, 2025

(54) METHOD FOR DETERMINING A SUITABLE TIME FOR TRANSMITTING DATA PACKAGES FROM A BACKEND TO AT LEAST ONE FIRST CONTROL UNIT OF A MOTOR VEHICLE

(71) Applicant: MERCEDES-BENZ GROUP AG, Stuttgart (DE)

(72) Inventors: Kerstin SCHMID, Nufringen (DE); Manuel GERSTER, Biberach an der Riß (DE)

(21) Appl. No.: 18/868,407

(22) PCT Filed: May 10, 2023
(86) PCT No.: PCT/EP2023/062403

§ 371 Date: Nov. 22, 2024

(30) Foreign Application Priority Data
May 24, 2022 (DE) 10 2022 001 837.3

(51) Int. Cl. H04L 67/125; H04L 1/1829

(52) U.S. Cl. CPC H04L 67/125; H04L 1/1835

(57) ABSTRACT

A suitable time for transmitting data packages from a backend to a control unit of a motor vehicle for controlling at least one functionality of the control unit is determined. Data packages are transmitted and received between the backend and the at least one control unit, and the transmission is triggered offboard and/or onboard the vehicle.

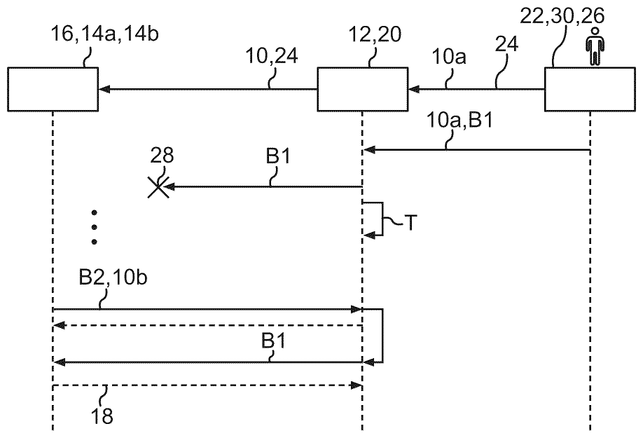

### BACKGROUND AND SUMMARY OF THE INVENTION

Exemplary embodiments of the invention relate to a method for transmitting data packets from a backend to at least one first control device of a motor vehicle.

Current vehicles or motor vehicles include numerous interlinked control devices or control units which exchange data with a vehicle backend, in which case a distinction can be made here between two types of functionalities.

On the one hand, such an exchange can be “offboard-triggered”, that is the exchange is triggered outside the vehicle. The initial data transmission for realizing corresponding functionalities takes place from the backend to the vehicle. The overall process usually corresponds to a “request/response pattern”, in which the backend sends a data packet to the vehicle, an example of a “request” would be a command to lock the vehicle, and the vehicle subsequently confirms the successful processing of the data packet, an example of a “response” would be a confirmation: “vehicle locked successfully”. The customer does not initiate these functionalities in/on the vehicle itself, but via a remote interface, such as for example a smartphone app, hence “offboard”.

On the other hand, such an exchange can be “onboard-triggered”, that is the exchange is triggered inside the vehicle. The initial data transmission for realizing corresponding functionalities takes place from the vehicle to the backend. Likewise, the overall process usually corresponds to a “request/response pattern”, in which the vehicle sends a data packet to the backend, a further example of a “request” would be a command to update status data, such as an ignition change or the locking status, with the backend subsequently confirming “response” the successful processing of the data packet. These functionalities are either initiated by the customer in/on the vehicle, when the customer unlocks the vehicle, for example, or are initiated by the vehicle itself, when the battery level drops, for example, hence “onboard”.

The backend does not usually communicate directly with the control device that processes the data packet in the vehicle, but via a so-called telecommunications unit (TCU) which includes a mobile radio module. The TCU ensures a secured connection to the backend, but the protocols that are employed do not guarantee a successful transmission or delivery of the data packet, at least not at an application level. In addition, messages can only be received by the TCU if the latter can be reached. According to the current prior art, it is possible for a data packet to get lost on the communication path, both on the path from the backend in the direction of the control device as well as in the opposite direction.

Due to external influences, there is the possibility that in the case of offboard-triggered functionalities, data packets may not be delivered to the vehicle, such as, for example, if there is no or a poor mobile radio connection. Despite this, there are data packets that absolutely have to be delivered to a vehicle for the successful provision of diverse offboard-triggered customer functionalities. Depending on the customer functionality, the delivery of the data packet does not necessarily have to take place immediately, however.

A remote control system with a configuration for correctly performing the application of the remote control to vehicle devices is disclosed in JP 2007 074017 A. In the remote control system, in which the remote control is applied to an onboard power supply, the performance takes place by requesting a vehicle to perform remote control of the onboard device via a control center from an operator terminal operated by the vehicle user.

A method to restore a cellular connection between a vehicle telematics unit and a wireless carrier system is already disclosed in U.S. Pat. No. 9,179,488 B2. This method comprises detecting a loss of cellular connection between a vehicle telematics unit and a wireless carrier system and accessing a technology order table (TOT) which orders a plurality of radio access technologies (RATs) according to the desirability, which are in turn capable for use with the vehicle telematics unit. Similarly, the method attempts to restore the cellular connection, in particular with different method steps.

A method for configuring access to a vehicle network from a mobile device is known from US 2019/0141023 A1. In the case of a failure, a corresponding signaling sequence is restarted.

US 2015/0133108 A1 discloses a method for offboard control of a telematics unit of a vehicle by a backend. Resending a request is briefly addressed without going into further details.

Exemplary embodiments of the invention are directed to a method in which data packets transmitted but not delivered to the vehicle are transmitted again to the vehicle at a suitable time, so that the data packets are more likely to be received by the vehicle.

Exemplary embodiments of the invention relate to a method for determining a suitable time to transmit data packets from a backend to at least one first control device of a vehicle, in particular a motor vehicle, in particular a passenger car, in order to control at least one functionality of the at least one control device. In this case, data packets are transmitted and received between the backend and the at least one control device, wherein the transmission is triggered offboard and/or onboard. It is also possible to transmit all of the data packets to different control devices for controlling different functionalities, wherein the transmission structure is provided with a prioritization, for example.

According to the invention, a timer is triggered in the event of an offboard-triggered transmission of at least one data packet to the first control device, in which confirmation information about the receipt of the transmitted and offboard-triggered data packet is awaited by the backend. If the confirmation information is received, the control of the functionality is confirmed and if the confirmation information is not received, the data packet is temporarily stored in a cache of the backend for future transmission. The temporarily stored data packets are transmitted to the backend in the event of an onboard-triggered transmission of further data packets from the same or a further control device and the temporarily stored data packet is transmitted once again to the first control device. In particular, the timer should enable messages that have not been delivered to the vehicle or data packets that have not been transmitted to the respective control device to be resent/retransmitted at a suitable time from the point of view of the backend. The timer recognizes that a message has most likely not been delivered. Retransmission at a suitable time is enabled via the onboard-triggered message and the cache.

The solution for determining a suitable time for resending data packets in the event of offboard-triggered functionalities is carried out with the aid of the onboard-triggered functionalities and assuming that communication between the backend and the vehicle takes place via a request/response pattern and that the vehicle can handle receiving the same data packets several times. In other words, the onboard-triggered functionality triggers a new attempt to transmit the data packets that were not transmitted when the offboard-triggered functionality failed. If, in the case of an offboard-triggered functionality, the response remains absent for a certain period of time or after the timer has expired, it must be assumed in the backend that the corresponding data packet has not reached the vehicle or the one control device. The backend must therefore temporarily store the data packet determined for the vehicle or for the one control device.

The suitable time or trigger for resending or retransmitting the data packet is then the successful receipt of data packets that the vehicle or the respective control devices send to the backend as part of an onboard-triggered functionality. The transmission of these data packets is triggered by the vehicle or the respective control devices themselves and therefore independently of the offboard-triggered functionality, for example when the customer unlocks the vehicle or changes the ignition and usually takes place in a context other than that of the offboard-triggered functionality. The receipt of a data packet from the vehicle or the respective control devices justifies the assumption that the vehicle or the control devices can be reached again and that data packets sent from the backend will therefore also be received with a very high probability. This means that the probability of an individual transmission without a request is lower than that of the method according to the invention, since here at least one further transmission is carried out.

In an advantageous embodiment of the invention, it is provided that a check is carried out to determine whether the retransmitted data packets are needed. This means that certain functionalities are checked in the cache to determine whether they are needed at the time when the onboard-triggered functionality appears. For example, it is no longer necessary to secure a lock after getting into the car, so it can be deleted from the cache again. To ensure security, for example, every functionality that is not carried out can be logged and saved for further processing, which means that less storage space and memory is required.

In a further advantageous embodiment of the invention, it is provided that the cache is deleted after a successful onboard-triggered transmission. The cache can be deleted either as a direct consequence of the onboard-triggered functionality or as a delayed consequence, with the OEM specifying the deletion. In particular, the security of the vehicle should be prioritized here.

Another advantageous embodiment of the invention has proven to be one in which information about unconfirmed transmissions of offboard-triggered data packets is transmitted to a data receiver. This is advantageous due to the security precaution at application level, as a user of the application receives a warning as soon as the backend receives confirmation information. This can lead to greater security for various functionalities, for example if the vehicle is not successfully locked.

Finally, it is provided in an advantageous embodiment of the invention that after a confirmed onboard-triggered transmission of data packets, a further second timer and/or further timers is/are triggered, in which the confirmation information about the receipt of the previously temporarily stored data packet of the offboard-triggered transmission is awaited again by the backend, and a signal for triggering an error message is generated if the data packet is once again not received. The error message confirms with a certain probability a possible interruption of an interface between the backend and the control device and informs the user or the OEM that a possible physical connection/interface or other components is/are defective.

This invention is from the field of telematics and describes a method which allows messages not delivered to the vehicle to be resent to the vehicle at a suitable time from the point of view of a vehicle backend.

Further advantages, features and details of the invention can be seen from the following description of a preferred exemplary embodiment and with reference to the drawing. The features and combinations of features mentioned above in the description as well as the features and combinations of features mentioned below in the description of the figure and/or shown alone in the single figure can be used not only in the combination indicated in each case, but also in other combinations or in isolation, without leaving the scope of the invention.

### BRIEF DESCRIPTION OF THE SOLE DRAWING

The single figure shows a schematic image diagram to represent a method according to the invention. In the figure, identical and functionally identical elements are provided with the same reference signs.

### DETAILED DESCRIPTION

The single figure shows an example for using the method according to the invention, in which for determining a suitable time to transmit data packets 10 from a backend 12 to at least one first control device 14a of a vehicle 16, in particular of a motor vehicle, in order to control at least one functionality of the at least one control device 14a. The data packets 10 are transmitted and received between the backend 12 and the at least one control device 14a, wherein the transmission is triggered offboard B1 and/or onboard B2. In the event of an offboard-triggered B1 transmission of at least one data packet 10 to the first control device 14a, a timer T is triggered, in which confirmation information 18 about the receipt of the transmitted offboard-triggered B1 data packet 10 is awaited by the backend 12, wherein, if the confirmation information 18 is received, the control of the functionality is confirmed and, if the confirmation information 18 is not received, and thus if non-confirmation information 28 is transmitted, the data packet 10 is temporarily stored in a cache 20 of the backend 12 for future transmission. The non-confirmation information 28 from the vehicle 16 to the backend 12 is, in particular, the expiry of the timer T, which information can be passed on to other entities. Finally, in the event of an onboard-triggered B2 transmission of further data packets 10b, the temporarily stored data packets 10 are retransmitted to the at least one control device 14a.

The single figure is based on an example in which a customer/user 22 wants to have a functionality of their vehicle 16, which is designed as an electric vehicle, configured as pre-air conditioning via the smartphone app 26 of the OEM in such a way that the pre-air conditioning is activated in the vehicle 16 on a specified afternoon at 2 pm, with this being an offboard-triggered B1 transmission of the data packets 10 for this functionality. In this case, a pre-air conditioning command 24 is transmitted via the backend 12 to the vehicle 16 for the pre-air conditioning. Here, initially a request data packet 10a is sent to the backend 12, and subsequently this data packet 10, in the form of a command data packet, is sent from the backend 12 to the vehicle 16 and/or the control device 14a. In other words, the data packets 10, 10a differ in that the command data packet or data packet 10 is sent between the vehicle 16 and the backend 12 and the data packet 10a is sent between the backend 12 and the customer/user 22.

Once the customer/user 22 configures a desired activation time in the smartphone app 26, the backend 12 sends a corresponding data packet 10, having a pre-air conditioning command 24 to configure the pre-air conditioning, to the vehicle 16 which contains the activation time among other things. If the backend 12 does not receive the expected confirmation information 18 or a “response” to the sent data packet 10 within a certain period of time or within the timer T, it can be assumed that the data packet 10 has not reached the vehicle 16 or the control device 14a and the pre-air conditioning 24 has not been configured according to the customer's request.

Instead of sending the data packet 10 to the vehicle 16 or to the control device 14a at cyclical intervals or having the customer/user 22 perform the configuration of the activation time again, the backend 12 waits according to the present method until it receives a further data packet 10b from the vehicle 16, which was sent as part of an onboard-triggered B2 functionality, for example when the vehicle 16 connected for charging sends a new charge status to the backend 12. This data packet 10b, which is not associated with the pre-air conditioning 24, thus triggers a repetition of the temporarily stored data packet 10, which is very likely to be received by the vehicle 16 or by the control device 14a and thus leads to a configuration of the pre-air conditioning 24 in the vehicle 16 and corresponding confirmation information 18 being sent to the backend 12.

1-5. (canceled)

6. A method for determining a time to transmit data packets from a backend to at least one first control device of a motor vehicle to control at least one functionality of the at least one control device, wherein data packets are transmitted and received between the backend and the at least one control device, wherein the transmission of the data packets is triggered offboard the motor vehicle or onboard the motor vehicle, the method comprising:
triggering a timer responsive to transmission of at least one data packet to the first control device, wherein the transmission of the at least one data packet is triggered offboard the motor vehicle, and wherein the at least one data packet is one that the backend expects to receive confirmation information about receipt of the at least one transmitted by the backend,
wherein, when the confirmation information is not received, the at least one data packet is temporarily stored in a cache of the backend for future transmission, and when a transmission of further data packets is triggered onboard the vehicle, the temporarily stored data packet is transmitted once again to the control device.

7. The method of claim 6, further comprising:
determining whether the at least one temporarily stored data packet is required to be sent.

8. The method of claim 6, further comprising:
deleting the cache after the transmission of the further data packets is successfully triggered onboard the vehicle.

9. The method of claim 6, wherein when confirmation information is not received in response to the transmission of the at least one data packet, the method further comprises:
transmitting, by the backend to a data receiver, non-confirmation information.

10. The method of claim 7, wherein after receiving confirmation information for the transmission of the further data packets, a second timer is trigger and after which the backend waits for further confirmation information about receipt of the temporarily stored data packet, and a signal for triggering an error message is generated when the temporarily stored data packet is not received.

11. A method comprising:
receiving, by a backend, a first trigger to send at least one data packet to a control device of a vehicle, wherein the first trigger is initiated offboard of the vehicle;
transmitting, by the backend, the at least one data packet to the control device of the vehicle;
starting, responsive to the transmission of the at least one data packet, a first timer;
determining that the backend did not receive confirmation information responsive to the transmission of the at least one data packet before expiration of the first timer and temporarily storing the at least one data packet in a cache of the backend;
receiving, by the backend, a second trigger to send at least one further data packet to the control device of the vehicle, wherein the second trigger is initiated onboard of the vehicle; and
transmitting, by the backend to the control device of the vehicle responsive to the receiving of the second trigger, the temporarily stored at least one data packet and the at least one further data packet.

12. The method of claim 11, wherein prior to transmitting the temporarily stored at least one data packet, the method further comprises:
determining whether the temporarily stored at least one data packet is still required.

13. The method of claim 11, further comprising:
receiving, by the backend, a confirmation of receipt of the at least one further data packet.

14. The method of claim 11, further comprising:
transmitting, by the backend to the control device of the vehicle in response to expiration of the first time, non-confirmation information.

15. The method of claim 13, further comprising:
starting, responsive to the transmission of the temporarily stored at least one data packet and after the receiving of the confirmation of receipt of the at least one further data packet, a second timer; and
triggering an error message responsive to not receiving a further conformation receipt for the transmitted temporarily stored at least one data packet before expiration of the second timer.
